(19) United States
(12) Patent Application Publication
(10) Pub. No.: US 2013/0220825 A1
(43) Pub. Date: Aug. 29, 2013

(54) METAL COMPLEX AND USE AS MULTI-ELECTRON CATALYST

(71) Applicants: Khurram Saleem Joya, Leiden (NL); Hubertus Johannes Maria De Groot, Leiden (NL)

(72) Inventors: Khurram Saleem Joya, Leiden (NL); Hubertus Johannes Maria De Groot, Leiden (NL)

(73) Assignee: UNIVERSITEIT LEIDEN, Leiden (NL)

(21) Appl. No.: 13/879,113

(22) PCT Filed: Oct. 5, 2011
(86) PCT No.: PCT/NL11/50673

§ 371 Date: May 13, 2013

(30) Foreign Application Priority Data
Oct. 14, 2010 (NL) 2005512

(51) Int. Cl. C25B 11/04; C07F 15/00

(52) U.S. Cl. CPC C25B 11/04; C07F 15/0046; C07F 15/0033
USPC 205/633; 546/2

(57) ABSTRACT

The invention is directed to a composition according to the following general formula: [(BL)-(M)-(Ar)-(X)]ⁿ⁺ (A)ⁿ-5 wherein M is a metal ion, BL is a bidentate ligand having two nitrogen atoms coordinating with a metal ion M, Ar is an, optionally substituted, conjugated cyclic hydrocarbon compound, X is H2O and A is an anion and n in n+ and n− are individually chosen from 1,2,3,4 or 5. The invention is also directed to its precursors and its use as multi-electron catalyst in a water splitting process.

The invention is directed to a metal complex composition and its use as a multi-electron catalyst.

The quest for a greener future through clean and affordable energy, fuel and electricity, using renewable natural resources, has become one of the most urgent challenges, spurred by worries about global warming and climate change. For example hydrogen obtained from water splitting using solar energy offers an attractive potential solution for clean solar fuel. It has been found that the design and implementation of stable multi-electron catalysts for efficient water oxidation (splitting) at high turnover rates for oxygen evolution is arguably the most challenging hurdle along the way.

In particular water splitting and oxygen evolving catalysts which can operate at a high catalytic turnover number (TON) and turn over frequency (TOF), with moderate activation energies and low overpotential are highly desirable. Water splitting is also referred to as catalytic water oxidation, oxygen evolution or electrolysis.

In an article by Chen, Z., Concepcion, J. J., Jurss, J. W. & Meyer, T. J. (Single-site, catalytic water oxidation on oxide surfaces. J. Am. Chem. Soc. 131 (2009) 15580-15581) it is described that electrocatalytic water oxidation at moderately high turnover numbers (TON) up to 11000, at ˜1.85 V (vs. NHE) in pH 5 buffer solution with turnover rates (TOF) of ˜0.36 sec⁻² at relatively low current density, ca. 15 μA/cm² are possible when using mononuclear ruthenium complexes on conducting oxide surfaces. The ruthenium complexes have tridentate and bidentate nitrogen based ligands, wherein ruthenium is coordinated with 5 nitrogen atoms and water.

Hull, J. F., Balcells, D., Blakemore, J. D., Incarvito, C. D., Eisenstein, O., Brudvig, G. W. & Crabtree, R. H, ‘Highly active and robust Cp* iridium complexes for catalytic water oxidation’, J. Am. Chem. Soc. 131 (2009) 8730-8731, describe another water splitting catalyst. The described homogeneous catalyst is an iridium complex, wherein iridium pentamethylcyclopentadiene is coordinated with 2-phenylpyridine or 2-phenylpyrimidine, and one exchangeable group, which can be Cl or OTf (trifluoromethanesulfonate). The TON is quoted as “>1500” with a TOF of 54 min⁻¹ (0.9 per sec). The catalyst was tested for 5.5 hours.

Nazeeruddin, Md. K., Zakeeruddin, S. M., Lagref, J.-J., Liska, P., Comte, P., Barolo, C., Viscardi, G., Schenk, K. & Graetzel, M. Stepwise assembly of amphiphilic ruthenium sensitizers and their applications in dye-sensitized solar cells. Coord. Chem. Rev., 248 (2004) 1317-1328, mentions [Ru(4,4′-dicarboxy-2,2′-bipyridine)Cl(cymene)]NO₃ as an intermediate complex to prepare a Ruthenium complex [Ru(L1)(L2)(Cl₂)], wherein L1 is 4,4′-dicarboxy-2,2′-bipyridine and L2 is 4,4′-dialkyl-2,2′-bipyridine. The thus prepared ruthenium complex is converted to [Ru(L1)(L2)(NCS)₂] and used as a charge-transfer photosensitizer in nanocrystalline TiO₂-based solar cells.

The object of the present invention is to provide a composition which can be used as a multi-electron catalyst for water splitting and which has improved catalytic properties as compared to the prior art catalysts.

This object is achieved by the following composition.

Composition according to the following general formula:

[(BL)-(M)-(Ar)—(X)]ⁿ⁺ (A)ⁿ⁻ (1)

wherein M is a metal ion, BL is a bidentate ligand having two nitrogen atoms coordinating with a metal ion M, Ar is an, optionally substituted, conjugated cyclic hydrocarbon compound, X is OH₂, A is an anion wherein n in n+ and n− are individually chosen from 1,2,3,4 or 5.

Applicants found that the composition, when used as a multi-electron catalyst, can catalyze the water splitting reaction at a high catalytic turnover number (TON) and turn over frequency (TOF). Additionally it has been found that the reaction can proceed with moderate activation energies and low overpotential over a wide pH range.

The metal ion M is suitably chosen from the group consisting of Ag, Au, Co, Fe, Ir, Mn, Mo, Ni, Os, Pd, Pt, Re, Rh and/or Ru. Preferably metal ion M is Ru, Ir, Mn, Co, Ni or Os, more preferably metal ion M is Ru or Ir.

The conjugated cyclic hydrocarbon Ar in the composition according to formula (1) can be any compound or ligand which has sufficient donating properties towards the metal centre M in the resulting complex. The conjugated cyclic hydrocarbon Ar compound is bonded to the metal ion M as a ligand by means of a non covalent boding so-called π-coordination. Mixtures of different compounds for Ar may be used. Ar is preferably a 5, 6 or 8 ring conjugated hydrocarbon. The hydrocarbon ring may be substituted, preferably with alkyl-groups, more preferably alkyl groups having 1 to 4 carbon atoms. Examples of suitable Ar compounds are cyclopentadiene (Cp), pentamethylcyclopentadiene (Cp*), benzene (bz), mesitylene (mt), p-cymene (cy), durene (dr), hexamethyl benzene (hmbz), cyclooctadiene (cod), cyclooctatetraene (cot) and/or polyaromatic hydrocarbons (PAHs). Preferred compounds Ar are pentamethylcyclopentadiene, benzene, mesithylene, p-cymene, hexamethyl benzene and/or cyclooctadiene.

In Organometallics, 21 (2002) 2088, a cationic platinum (II) complex with a 2,2′-bipyridine ligand complex is described. The cationic phenyl aqua complex [PtPh(bpy)(H₂O)]BF₄ as described on page 2089 is different from the composition according to the present invention in that the phenyl group of this complex is covalently bonded to the platinum ion. The covalent boding of this aryl-group is different from the 7-coordination between the metal ion and the conjugated cyclic hydrocarbon Ar compound in the composition according to the present invention.

The anion A in formula (1) may be any suitable anion which has sufficient electron acceptor properties to stabilize the resulting charge transfer complex. The suitable anion A in formula (1) may be halides (F⁻, Cl⁻, Br⁻, I⁻), carbonate (CO₃²⁻), bicarbonate (HCO₃⁻), hydroxide (OH⁻), nitrate (NO₃⁻), sulfate (SO₄²⁻), hexafluoro phosphate (PF₆⁻) and/or tetrafluoro borate (BF₄⁻), chlorate (ClO₃⁻), perchlorate (ClO₄⁻), acetate/ethanoate (CH₃COO⁻), formate/methanoate (HCOO⁻), oxalate/ethanedioate (C₂O₄²⁻), cyanide (CN⁻) and the like. Preferably n is 1 or 2. Examples of suitable anions A wherein n is 1 are halides (F⁻, Cl⁻, Br⁻, I⁻), NO₃⁻, PF₆⁻, BF₄⁻, chlorate (ClO₃⁻), and/or perchlorate (ClO₄⁻) and wherein n is 2 are SO₄²⁻, oxalate/ethanedioate (C₂O₄²⁻) and/or carbonate (CO₃²⁻), and the like.

Preferably the direct bridge connecting the two nitrogen atoms of the bidentate ligand BL of formula (1) contains two carbon atoms. Such a preferred catalyst is schematically shown below in formula (2) (not showing the anion A), wherein the line between the two nitrogen atoms is the direct bridge and wherein the Ar in the circle represents the optionally substituted, conjugated cyclic hydrocarbon and wherein X is OH₂ and M is the metal, preferably Ru or Ir. Only the part of ligand BL is shown by means of the below formula.

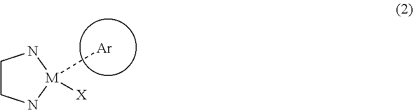

A preferred ligand BL is, optionally substituted, 2,2′-bipyridine (bpy). Other possible ligands are, optionally substituted, 2,2′- and 4-4′-bipyrimidine(bpm), 2,2′-bipyrazine(bpz), 3,3′-bipyridazine (bpdz), 2,2′-Biquinoline(2,2′-Diquinolyl or Cuproin)(bq), phenanthroline(phen), tetraazaphenanthren(tap), hexaazatriphenylen(hat), 2,3-bis(2-pyridyl)pyrazine(dpp), dipyrido[3,2-d:2′,3′-f]quinoxaline(dpq), dipyrido[3,2-a:2′,3′-c]phenazine(dppz), 3,5-bis-(2-pyridyl)-1H-pyrazole(Hbpp), 3,6-Bis(2-pyridyl)pyridazine(dppd), 3,6-di-2-pyridyl-1,2,4,5-tetrazine(dptz) and 3,6-Bis(2′-pyrimidyl)-1,2,4,5-tetrazine(bmtz).

The ligand may optionally have two pairs of nitrogen atoms, each pair individually coordinating with a single metal ion M. An example of such a ligand is 2,2′-bipyrimidine.

The ligand may optionally have three pairs of nitrogen atoms, each pair individually coordinating with a single metal ion M. An example of such a ligand is hexaazatriphenylen (hat).

The ligand may optionally have four pairs of nitrogen atoms, each pair individually coordinating with a single metal ion M. An example of such a ligand is 3,6-bis(2′-pyrimidyl)-1,2,4,5-tetrazine(bmtz).

The ligand may be substituted. Examples of suitable substituents are halogen, nitro, nitrite, nitroso, amine, imine, imide, azide, azo(diimide), cyanate, isocyanate, nitrile(cyanide), phenyl, benzyl, alkyl, alkenyl, alkynyl (saturated or unsaturated hydrocarbons), carbonyl, formyl, acetyl, carboxylic acid, carboxylate, ester, ether, amide, anhydride, sulfonic acid/sulfonate, sulphide(thioether), disulfide, sulfonyl, sulfinyl, thiocyanate, hydroxyl, thiol(sulfhydryl), acetyl thiol, phosphonic acid, phosphate, triflate, heterocycles. For example the preferred 2,2-bipyridine may be mono- or di-functionalized at its 3,3′-, 4,4′-, 5,5′- and 6,6′-postion and preferably at its 4,4′-position.

The invention is especially directed to the following composition wherein the composition, not showing the anion, is represented by:

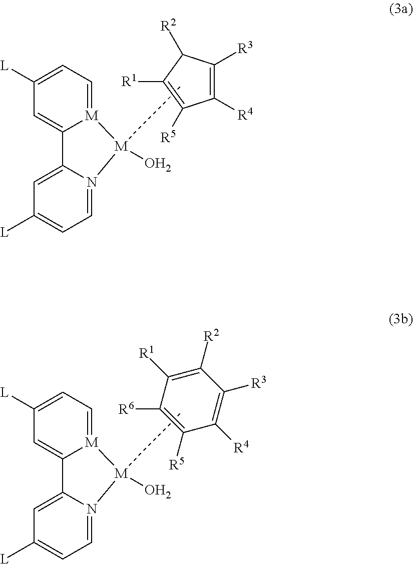

Wherein M is Ir or Ru and L is —H, —SH, —PO₃H₂ or —COOH. R¹-R⁵ in 3a and R¹-R⁶ in 3b are suitably electron donating or withdrawing groups, suitably individually chosen from the group of H or a C1-C4 alkyl, for example methyl, ethyl, propyl, iso-propyl or butyl.

The composition may be used as homogeneous multi-electron transfer catalyst in combination with a one-electron oxidizing agent, such as for example cerium ammonium nitrate (NH₄)₂Ce(NO₃)₆.

Applicants found that the composition according to the invention and especially the composition according to formula (3a) and (3b) is suited as a heterogeneous multi-electron catalyst for use as a water splitting catalyst when linked to an electrode through linker groups L substituted on the ligand BL.

The ligand BL is linked to the electrode via linker groups L. Preferred linker groups are —COOH, —SH or —PO₃H₂ groups. In a more preferred embodiment the electrode is linked with a 2,2′-bipyridine ligand according to formula (3a, 3b) via a —COOH, —SH or —PO₃H₂ linker group, which linker groups are substituted at the 4,4′positions of the 2,2′-bipyridine ligand. A preferred complex ion part [(BL)-(M)-(Ar)—(X)]n⁺ is [(cy)Ru^{II}(H₂dcabpy)-OH₂]²⁺, wherein cy is p-cymene and H₂dcabpy is of 4,4′-dicarboxylic acid-2,2′-bipyridine.

The electrode is preferably a conductive or semi-conductive surface. Examples of possible materials for the electrode are gold, platinum, silver, carbon, glassy or vitreous carbon, simple or pyrrolytic graphite and conductive polymers. More preferably the material is a conductive oxide surface or semi-conductive oxide surface, for example Fe₂O₃, TiO₂, Indium doped tin oxide (ITO) and fluorine doped tin oxide (FTO) or optically transparent films of tin oxide nanoparticles. The ligand is preferably connected to the electrode by contacting an aqueous solution of the catalyst with the electrode. Alternatively the catalyst can be linked by spin coating a solution of the composition according to the invention as for example illustrated in the examples.

The invention is also directed to an electrode linked with a composition according to the present invention according to the following general formula:

E-L-[(BL)-(M)-(Ar)—(X)]ⁿ⁺ (A)ⁿ⁻ (4)

wherein E is a conductive or semi-conductive surface of an electrode as described above, L is a linker group as described above and M, BL, Ar, A and n are as described above, including their preferred embodiments and combinations, and wherein X is OH₂.

The invention is also directed to a process for splitting water into protons and oxygen by means of electrolysis wherein a catalyst as described above is used or an electrode modified with the catalyst as described above is used. The protons can advantageously be used to make hydrogen, a chemical compound or a carbon based fuel. The carbon based fuel may suitably be methanol, ethanol or formic acid. An example of a process to prepare formic acid from protons and carbon dioxide is described in WO-A-2010/010252.

The required overpotential of the electrolysis process is preferably provided by a source of sustainable energy selected from wind, solar, wave or tidal power energy.

The composition according to the invention as described above can be obtained by a 2-step process. The first step can be performed as described in the earlier referred to article of Nazeeruddin et al. in Coord. Chem. Rev., 248 (2004) 1317. This publication describes the preparation of [Ru(4,4′-dicarboxy-2,2′-bipyridine)Cl(cymene)]NO₃. By subsequently exchanging the chloride with water in a second step a composition according to the invention is obtained.

The first step of the synthesis process may for example be performed by (a) heating a mixture of [RuCl₂(Ar)]₂ or [IrCl₂(Ar)]₂ dimer with an optionally modified bipyridine ligand in methanol, (b) filtering the resulting chloro complexes and (c) drying. The chloro complexes may be converted to the desired aqua (OH₂) complex in a second step by stirring with aqueous AgNO₃ or AgPF₆ or AgBF₄ in methanol. The modified bipyridine ligand may have —SH, —SR, —COOH, —COOR, —PO₃H₂, or —PO₃R₂ groups, wherein R is an optionally protective group, preferably alkyl or acetyl, on its 4,4′-positions when preparing compositions according to formula (3a) and (3b) as described above.

In the above described 2-step synthesis of the composition according to the present invention a precursor composition is suitably prepared in the first step. The present invention is also directed to the use of such a precursor composition to prepare the composition according to the invention. Especially a precursor according to the following general formula is claimed, wherein

[(BL)-(M)-(Ar)—(X)]n⁺ (A)ⁿ⁻ (5)

wherein M, BL, Ar and the anion Aⁿ⁻ correspond with the composition to be prepared according to the present invention and wherein X is a group exchangeable with water and preferably CN, RCN, Cl, PPh₃ (triphenylphosphine) or OTf (trifluoromethanesulfonate), wherein R is an alkyl group (C1-C4) or S. The precursor can be converted to the composition according to the invention by exchanging the non-aqueous group X by water, for example by means of the method described above.

The invention is also directed to a novel class of precursor compositions according to the following general formula:

[(BL)-(M)-(Ar)—(X)]ⁿ⁺ (A)ⁿ⁻ (6)

wherein M is a metal ion, BL is an optionally substituted bidentate ligand having two nitrogen atoms coordinating with metal ion M, Ar is an, optionally substituted, conjugated cyclic hydrocarbon compound, X is an with water exchangeable group, preferably the above listed groups X and A is an anion and wherein n in n+and n- are individually chosen from 1,2,3,4 or 5 and wherein the composition is not [Ru(4,4′-dicarboxy-2,2′-bipyridine)Cl(cymene)]NO₃.

The preferred embodiments for M, BL, Ar and the anion A in the above formulas (5) and (6) for the precursor composition is the same as the preferred embodiments for the composition according to the invention.

Preferably the composition according to the invention is prepared by means of the following 1-step synthesis route wherein the ligand BL is dissolved in an aqueous alkanol mixture, suitably water/methanol. To this mixture a [MX₂ (Ar)]₂-dimer, oligomer or polymer, for example [RuCl₂(benzene)]₂ dimer, dissolved in alkanol, suitably methanol is added. The mixture is stirred at a temperature of preferably between 25 and 40° C., wherein the final composition according to formula (1) is obtained as a solid after filtration and drying. The composition is suitably further purified by means of re-crystallisation, for example re-crystallisation from methanol by addition from an ether and/or hexane mixture and dried.

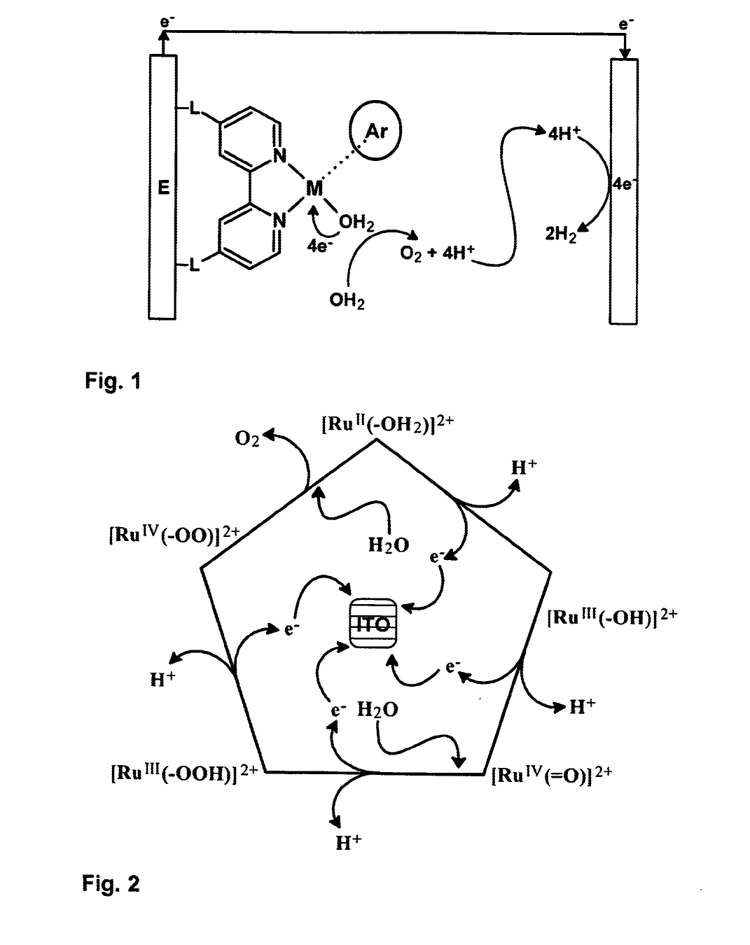

The invention will be illustrated making use of FIGS. 1-11.

FIG. 1 schematically shows the mechanism of water splitting making use of the catalyst.

FIG. 2 illustrates the possible mechanism for a catalyst according to the invention.

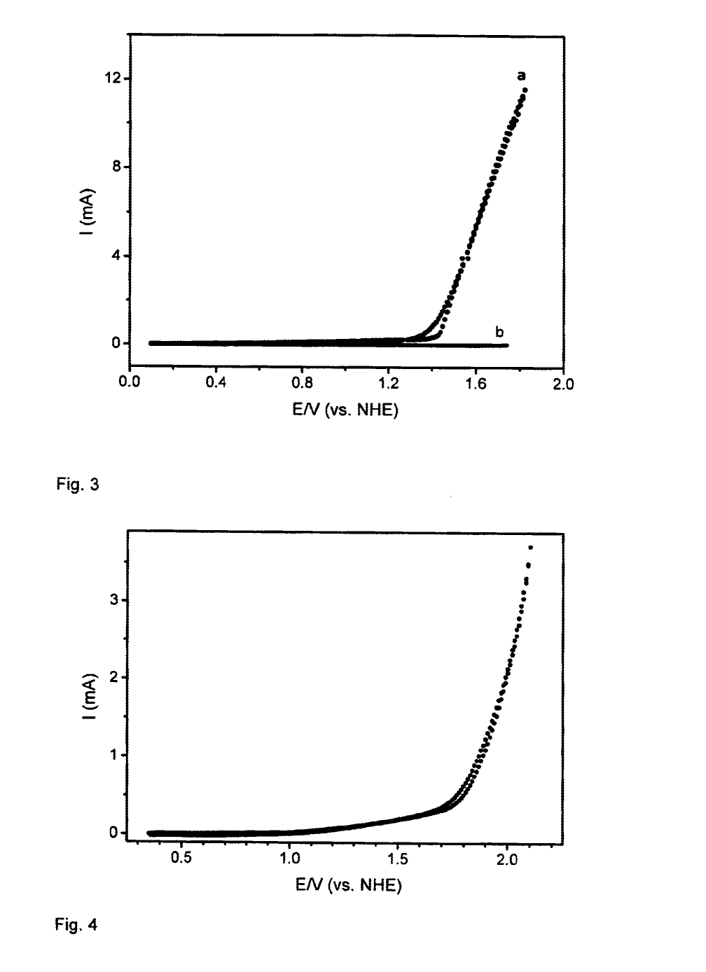

FIG. 3 is a cyclic voltammogram of Example 24.

FIG. 4 is a cyclic voltammogram of Example 25.

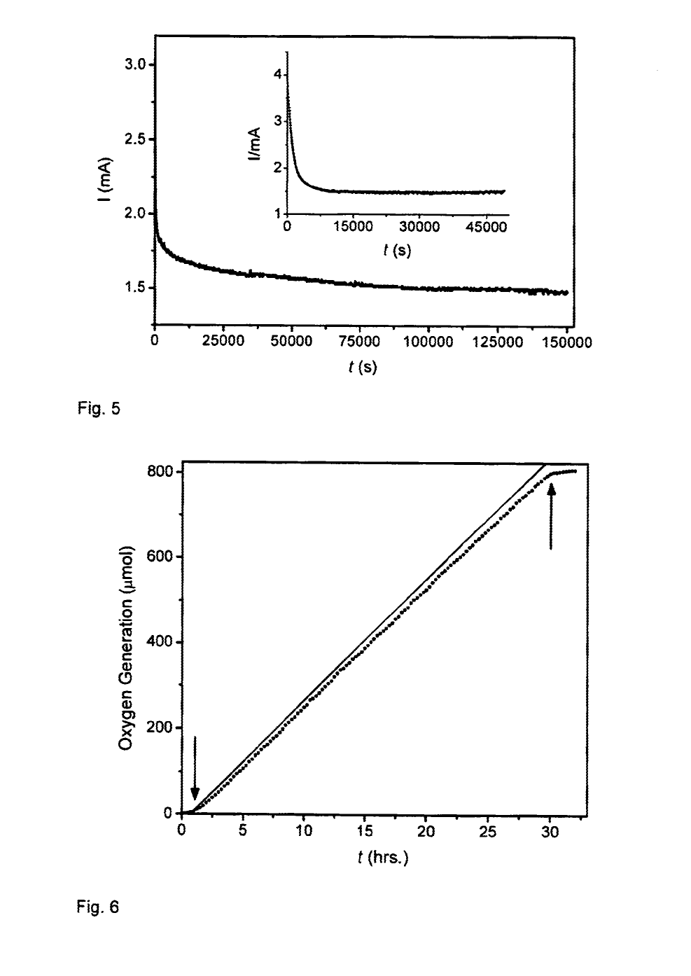

FIG. 5 shows the current vs. time plot for the water electrolysis of Example 26.

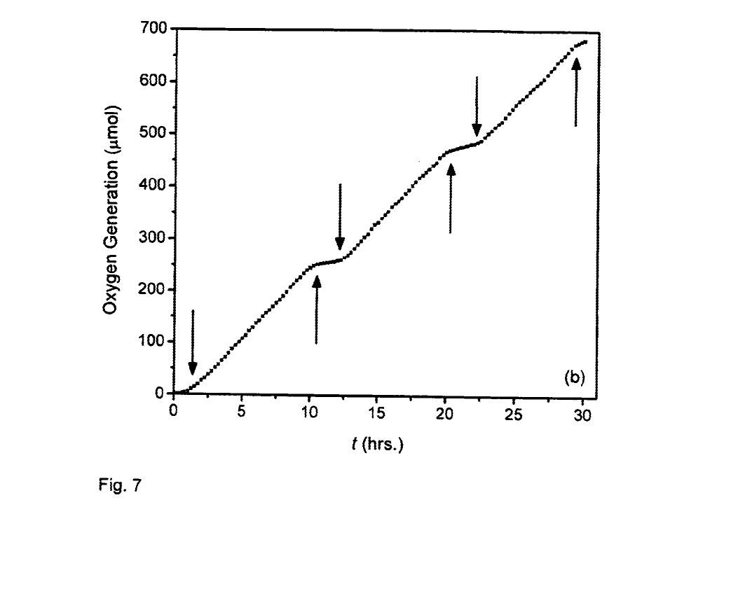

FIG. 6 shows the oxygen generation versus time in hours of Example 27. Down and up arrows indicate the on and off mode of the electrolysis.

FIG. 7 shows the activity of the catalyst for three electrolysis runs in a sequence of Example 28.

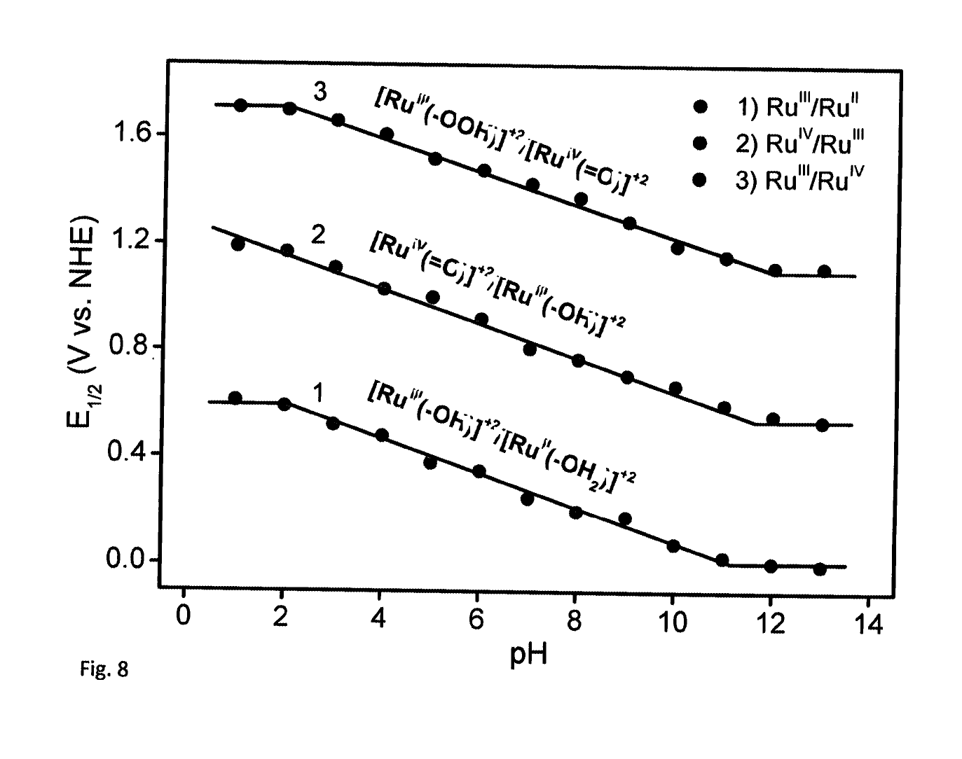

FIG. 8 shows the potential versus pH plot for various ruthenium redox couples generated during water splitting and oxygen evolution.

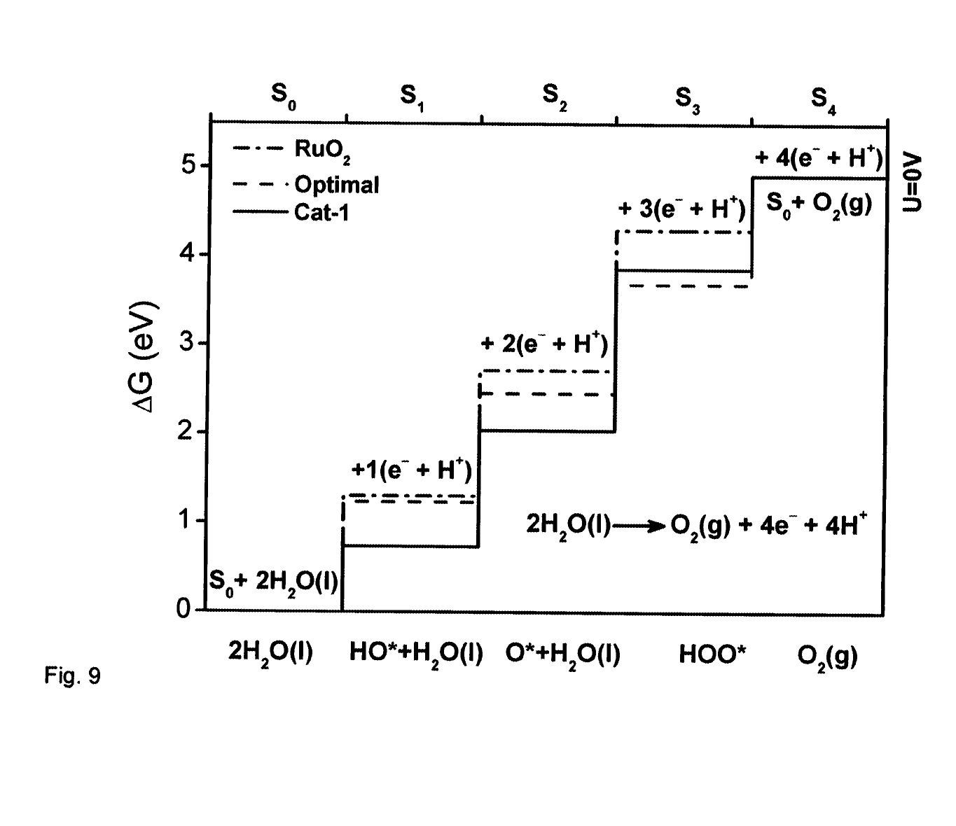

FIG. 9 shows the comparison of the free energies (AG) of various reactive species and intermediates during water splitting.

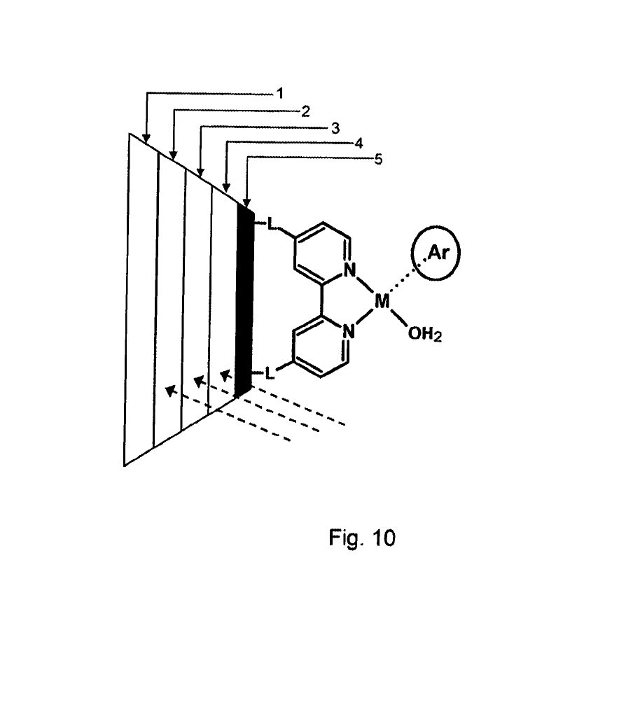

FIG. 10 shows a catalyst according to the invention integrated with a so-called Triple-Junction Solar Cell for light driven water splitting assembly.

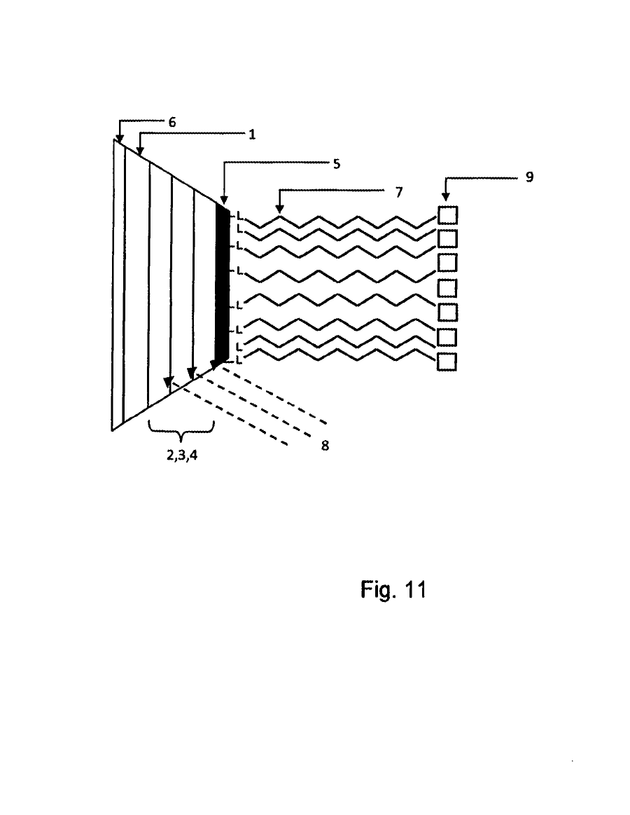

FIG. 11 shows a catalyst according to the invention integrated with a so-called Triple-Junction Solar Cell for light driven water splitting assembly, wherein the catalyst is linked to the Triple-Junction Solar Cell via a tunneling layer.

FIG. 1 shows a composition according to the present invention for use as a catalyst linked to an ITO (indium doped tin oxide) electrode. As shown, electrons are forced from the ITO electrode to the platinum electrode. Water is split under the influence of the catalyst into molecular oxygen and H⁺ thereby releasing an electron to the ITO electrode. The protons migrate to the platinum electrode where the electron is picked up by the proton to form hydrogen.

FIG. 2 illustrates the possible mechanism for water splitting using a composition according to the present invention as a catalyst linked to an ITO via —COOH groups and wherein M is ruthenium. Without wishing to be limited by this theory applicants believe that the electro-assisted water oxidation and oxygen evolution by this catalyst is performed according to the pentacycle catalytic mechanism as shown. Arrows represent four steps electron removal each coupled with a proton transfer and arrows indicating electron transfer to the ITO electrode via the carboxylic linker group. Characteristic for the mechanism is a complex with overall charge +2 and alternating Ru oxitation states: Ru^{II}/Ru^{III}/R^{IV}-Ru^{II}/Ru^{III}/Ru^{IV} that are enabled by rapid, non-ratelimiting internal rearrangements following association of a second water molecule and following exchange of O₂ by H₂O. Typical for the present mechanism is that the Ru oxidation state Ru^{V} is not observed. This observation is believed to be reason why the composition, when used as a multi-electron catalyst, can be used over a wide pH range at a moderate overpotential. The pH range at which the water splitting process can be performed is between 0 and 13, preferably between 2 and 12 and most preferred at about pH is 7 using a buffered aqueous solution. The fact that the process can be performed at neutral conditions is an advantage of the present invention. Known multi-electron catalyzed water splitting processes will work at (highly) acidic conditions in an optimal manner.

FIG. 10 shows a catalyst according to the invention integrated with a so-called Triple-Junction Solar cell or a Tandem water splitting device. The solar cell comprises a substrate 1, a first amorphous and/or monocrystalline and/or polycrystalline photoelectric element 2, a second amorphous and/or monocrystalline and/or polycrystalline photoelectric element 3, a third amorphous and/or monocrystalline and/or polycrystalline photoelectric element 4 and an upper transparent conducting material layer 5. To the transparent conducting layer 5 the compound according to the invention is linked via linker group L. The transparent conducting layer 5 may be a thin film of a conducting oxide coating of indium doped tin oxide (ITO) or fluorine doped tin oxide (FTO), a light permeable conducting material or metal and/or a transparent light permeable conducting polymer thin film. The third amorphous and/or monocrystalline and/or polycrystalline photoelectric element 4, also referred to as the Blue cell absorbs blue light and transmits longer wave length. The second amorphous and/or monocrystalline and/or polycrystalline photoelectric element 3, also referred to as the Green cell, absorbs green color and transmits remaining longer wave length. The first amorphous and/or monocrystalline and/or polycrystalline photoelectric element 2, also referred to as the Blue cell, absorbs red light. The substrate 1, also referred to as a back reflector is preferably made of an anti-reflective coating. Normally, a tunnel junction material, i.e. a highly doped diode with wide band gap, is present between two adjacent photoelectric elements that provide a low electrical resistance and optically low-loss connection between two photoelectric elements. Triple-Junction Tandem Solar cell as such are known and are for example described in WO-A-2011/014023.

Preferably the compound according to the invention is linked to the anode side of a Triple-Junction Solar Cell via a tunneling layer as shown in FIG. 11 to avoid corrosion of the cell due to the oxygen generated at the anode side. FIG. 11 shows the Triple-Junction Solar Cell of FIG. 10, wherein reference numbers 1-5 have the same meaning. Additionally a substrate 6 is shown. The compound according to the invention 9 is connected to the transparent conduction layer 5 via a tunneling layer 7. Tunneling layer 7 preferably is composed of a multitude of predominantly linear alkyl chain, having suitably 11 to and including 23 carbon atoms, attached to layer 5 via linker groups L, wherein L is suitably, —S—, —PO₃— or —COO—. The compound according to the invention is suitably connected to the other end of the alkyl groups to the bidentate ligand BL of the compound (9) according to the invention. FIG. 11 also shows the incident solar radiation 8.

The cathode side of the catalyst coupled multi-junction solar cell will be coated with a hydrogen evolving catalyst layer or a thin film of transition metal or alloy based material for proton reduction (generated after water splitting) to make hydrogen. The thus obtained cell provides a light driven efficient catalytic system operating at high catalytic turnover and rapid rate not requiring an external power source as the system is fully operated under sun light. Known multi-junction solar cells may advantageously be adapted to provide such a robust and durable integrated set up for direct conversion of solar energy into fuel starting from water. The water may be for example normal tap water, rain water, spring or river water.

The above cell is advantageous because it has the ability for a self-repair mechanism induced in an electro-deposition manner.

The invention shall be illustrated using the following non-limiting examples.

Materials and Methods.

Unless otherwise specified, all the solutions in the examples were prepared in ultra-pure water (Millipore MilliQ® A10 gradient, 18.2 MΩ cm, 2-4 ppb total organic content). All electrochemical measurements were carried out in carefully Ar-purged deoxygenated aqueous solutions at room temperature. All the compounds, ligands and compositions were synthesized in argon/nitrogen atmosphere. ITO coated glass slide (10×2.5 cm) and RuCl₃.nH₂O were obtained from Sigma-Aldrich Co., and used as received. [RuCl₂(Ar)]₂ dimer (Ar is benzene, mesitylene, p-cymene, hexamethylbenzene), [RuCl₂(Ar)]₂ tetramer or polymer (Ar is Cp or Cp*), [IrCl₂(Cp*)]₂ dimer, tri-aquo complex [(M)(Ar)—(OH₂)₃]²⁺ (M is Ir, Ru), 4,4′-dicarboxylic acid-2,2′-bipyridine (H₂dcabpy) and 4,4′-diphosphonic acid-2,2′-bipyridine (H₄dphbpy) and various substituted 2,2′-bipyridine and other ligands were prepared using literature procedures.

¹H NMR spectra were obtained on a Bruker WM-300 MHz spectrophotometer. UV-vis spectra were recorded by using Varian DMS 200 spectrophotometers with Teflon-stoppered quartz cells having a path length of 1 cm.

All the glassware and cells were decontaminated by boiling in a 1:2 mixture of concentrated nitric acid and sulfuric acid. The glass apparatus was then washed and boiled in ultra-pure water and ultimately, dried in an oven at 75° C. The cell was boiled 3 times in ultra-pure water followed by through washing before each experiment. A mirror finished glassy carbon disk (5 mm diameter, WE) was achieved by polishing mechanically with an aqueous slurry of 0.3, 0.1 and 0.05 μm alumina (Buehler Limited) successively, on a microcloth polishing fabric. After polishing, the GC disk was ultrasonically cleaned in Milli-Q (Millipore) water for 15 minutes after each polishing step and rinsed thoroughly with pure water. The spiral platinum counter electrode was flame annealed and washed with pure water before placing into the cell.

Prior to the water splitting investigation and oxygen measurement experiments, the aqueous solutions were purged with high-purity argon (Linde Gas, 6.0) at least 30 min before each measurement. The whole cell assembly was air tight and great care has been taken into account in order to prevent any passage of air/oxygen into the test solution/cell. Oxygen elimination from the continuously Ar-bubbled aqueous solutions was carefully verified by scanning the freshly polished Pt disk (3 mm diameter embedded in PTFE) electrode on RDE assembly from 500-2500 rpm until no oxygen detection was observed.

Instrumentations.

Electrochemical investigations and cyclic voltammetry were performed with an Autolab PG-stat10 potentiostat controlled by GPES-4 software. The controlled-potential water electrolysis investigations were conducted with an IviumStat and the applied potential was computer-controlled with Iviumsoft software.

### EXAMPLE 1

To a 50 mL of a dissolved solution of 2,2′-bipyridine (bpy) (1.0 mmol) in methanol (MeOH) 0.5 mmol of [RuCl₂(benzene)]₂ dimer (in 15 mL MeOH) was added. The mixture was further stirred for 2 hours at 25-35° C. The solution was filtered through sintered glass funnel of fine porosity and the solvent was evaporated under vacuum. The solid orange chloro complex [(bz)Ru^{II}(bpy)Cl]⁺ thus obtained was pure and recrystallized from MeOH by addition of ether/hexane, filtered and dried.

The chloro complex [(bz)Ru^{II}(bpy)Cl]⁺ obtained from above method was subsequently converted into its aqua (OH₂) version [(bz)Ru^{II}(bpy)-OH₂]²⁺ by stirring with an aqueous solution containing 1.1 eq. of AgNO₃ in methanol (1:1, H₂O/MeOH) for 30 minutes. The white precipitates were filtered off and the solvent was evaporated under vacuum. The yellow solid aqua (OH₂) complex thus obtained was further purified by recrystallization from MeOH by addition of ether/hexane, filtered and dried.

¹H NMR analysis showed that a composition according to formula 1 is obtained wherein Ar is benzene, LB is bipyridine (bpy), X is OH₂ and (A)ⁿ⁻ is NO₃⁻ (referred to as Cat 1-H).

### EXAMPLE 2

The same composition as in Example 1 was prepared in a single synthesis step wherein 1.0 mmol 2,2′-bipyridine (bpy) was first completely dissolved in 50 mL water MeOH mixture. This mixture was added to 25 mL of a methanol solution of 0.5 mmol [RuCl₂(benzene)]₂ dimer. The mixture was stirred for 2 hours at 25-35° C. giving orange yellow solution. After filtration through sintered glass funnel of fine porosity, a few drops of HNO₃ were added and the solvent was evaporated to yield yellow solid which was further dried in vacuo. The solid pale yellow aqua (OH₂) complex thus obtained was further purified by recrystallization from MeOH by addition of ether/hexane, filtered and dried.

¹H NMR analysis showed that a composition according to formula 1 is obtained wherein Ar is benzene, LB is bipyridine (bpy), X is OH₂ and (A)ⁿ⁻ is NO₃⁻ (Cat 1-H). Example 2 illustrates that Cat 1-H can be obtained in a more simple process than the 2-step process of Example 1.

### EXAMPLE 3

The same composition as in Example 1 or 2 was prepared in another single synthesis step, wherein 1.0 mmol 2,2′-bipyridine (bpy) was first completely dissolved in 35 mL H₂O:MeOH mixture. This mixture was added to 15 mL of aqueous solution of tri-aquo [(Ru)(bz)-(OH₂)₃]²⁺ (1.0 mmol). The mixture was stirred for 5-6 hours at 65° C. giving yellow solution. After filtration through sintered glass funnel of fine porosity, few drops of HNO₃ was added and the solvent was evaporated to yield yellow solid which was further dried in vacuo. The solid pale yellow aqua (OH₂) complex thus obtained was further purified by recrystallization from MeOH by addition of ether/hexane, filtered and dried.

¹H NMR analysis showed that a composition according to formula 1 is obtained wherein Ar is benzene, LB is bipyridine (bpy), X is OH₂ and (A)ⁿ⁻ is NO₃⁻ (Cat 1-H). Example 3 illustrates that Cat 1-H can be obtained in a more simple process than the 2-step process of Example 1.

### EXAMPLE 4

25 mL of methanol was added to 1 mL of a (MeOH/H₂O) dissolved solution of 4,4′-dicarboxylic acid-2,2′-bipyridine (H₂dcabpy) (1.0 mmol) and NaOH/NaOMe (2.0 mmol) and mixed well. In a first step the solution was poured into 30 mL of a stirred mixture of methanol and 0.5 mmol [RuCl₂(benzene)]₂ dimer (0.5 mmol). The resultant mixture was further stirred for 2 hours at 25-35° C. After filtration through sintered glass funnel of fine porosity, the pH was lowered to 1-2 by addition of 0.5 M HCl. The free ligand was filtered off and the solvent mixture was evaporated under vacuum. The solid orange chloro complex [(bz)Ru^{II}(H₂dcabpy)Cl]⁺ thus obtained was pure and recrystallized from MeOH by addition of ether/hexane, filtered and dried. Instead of NaOH/NaOMe the same qauntility of tetraalkyl-NOH can be used to get the same results. NaOMe is sodium methoxide.

The chloro complex [(bz)Ru^{II}(H₂dcabpy)Cl]⁺ as obtained above was converted into aqua (OH₂) version [(bz)Ru^{II}(H₂dcabpy)-OH₂]²⁺ (Cat 1-COOH) by stirring with aqueous solution containing 1.1 eq. of AgNO₃ in methanol (1:1, H₂O/MeOH) for 30 minutes. The white precipitates were filtered off and the solvent was evaporated under vacuum. The yellow solid composition thus obtained was further purified by recrystallization from MeOH by addition of ether/hexane, filtered and dried.

¹H NMR analysis confirmed that a composition [(bz)Ru^{II}(H₂dcabpy)-OH₂] (NO₃)₂ (Cat 1-COOH) was prepared.

### EXAMPLE 5

The same composition (Cat 1-COOH) as in Example 4 was prepared in a single synthesis step wherein a mixture of 1.0 mmol of 4,4′-dicarboxylic acid-2,2′-bipyridine (H₂dcabpy) and 2.0 mmol NaOH/NaOMe as dissolved in 25 mL water was added to a 25 mL of a methanol solution of [RuCl₂(benzene)]₂ dimer (0.5 mmol). The mixture was stirred for 2 hours at 25-35° C. giving a yellow solution. After filtration through sintered glass funnel of fine porosity, a few drops of HNO₃ were added, filtered again and the solvent was evaporated to yield yellow solid which was further dried in vacuo. The solid pale yellow aqua (OH₂) complex Cat 1-COOH thus obtained was pure and further purified by recrystallization from MeOH by addition of ether/hexane, filtered and dried.

Example 5 illustrates that Cat 1-COOH can be obtained in a more simple process than the 2-step process of Example 4.

### EXAMPLE 6

The same composition (Cat 1-COOH) as in Example 4 or 5 was prepared in another single synthesis step, wherein a mixture of 1.0 mmol of 4,4′-dicarboxylic acid-2,2′-bipyridine (H₂dcabpy) and 2.0 mmol NaOH/NaOMe as dissolved in 35 mL water was added to a 15 mL of aqueous solution of tri-aquo [(Ru)(bz)-(OH₂)₃]²⁺ (1.0 mmol).

The mixture was stirred for 5-6 hours at 65° C. giving yellow solution. After filtration through sintered glass funnel of fine porosity, few drops of HNO₃ was added, filtered again and the solvent was evaporated to yield yellow solid which was further dried in vacuo. The solid pale yellow aqua (OH₂) complex Cat 1-COOH thus obtained was further purified by recrystallization from MeOH by addition of ether/hexane, filtered and dried.

Example 6 illustrates that Cat 1-COOH can be obtained in a more simple process than the 2-step process of Example 4.

### EXAMPLE 7

Example 4 was repeated using phosphonic ligand 4,4′-diphosphonic acid-2,2′-bipyridine (H₄dphbpy) instead of carboxylic ligand 4,4′-dicarboxylic acid-2,2′-bipyridine (H₂dcabpy) to prepare [(bz)Ru^{II}(H₄dphbpy)-OH₂]²⁺ (Cat 1-PO₃H₂). In this synthesis a precursor composition according to [(bz)Ru^{II}(H₄dphbpy)-Cl]⁺ was prepared as intermediate composition. The anion was chloro for the intermediate composition and nitrate in the final composition.

### EXAMPLE 8

Example 1 was repeated using [RuCl₂(p-cymene)]₂ dimer instead of [RuCl₂(benzene)]₂ dimer or tri-aquo [(Ru)(cy)-(OH₂)₃]²⁺ instead of tri-aquo [(Ru)(bz)-(OH₂)₃]²⁺ to prepare a ruthenium bipyridine composition according to [(cy)Ru^{II}(bpy)-OH₂]²⁺ (Cat 2-H). In this synthesis a precursor composition according to [(cy)Ru^{II}(bpy)-Cl]⁺ was prepared as intermediate composition. The anion was chloro for the intermediate composition and nitrate in the final composition.

### EXAMPLE 9

Example 4 was repeated using [RuCl₂(p-cymene)]₂ dimer instead of [RuCl₂(benzene)]₂ dimer or tri-aquo [(Ru)(cy)-(OH₂)₃]²⁺ instead of tri-aquo [(Ru)(bz)-(OH₂)₃]²⁺ to prepare [(cy)Ru^{II}(H₂dcabpy)-OH₂]²⁺ (Cat 2-COOH). In this synthesis a precursor composition according to [(cy)Ru^{II}(H₂dcabpy)-Cl]⁺ was prepared as intermediate composition. The anion was chloro for the intermediate composition and nitrate in the final composition.

### EXAMPLE 10

Example 7 was repeated using [RuCl₂(p-cymene)]₂ dimer instead of [RuCl₂(benzene)]₂ dimer or tri-aquo [(Ru)(cy)-(OH₂)₃]²⁺ instead of tri-aquo [(Ru)(bz)-(OH₂)₃]²⁺ to prepare [(cy)Ru^{II}(H₄dphbpy)-OH₂]²⁺ (Cat 2-PO₃H₂). In this synthesis a precursor composition according to [(cy)Ru^{II}(H₄dphbpy)-Cl]⁺ was prepared as intermediate composition. The anion was chloro for the intermediate composition and nitrate in the final composition.

### EXAMPLE 11

Example 1 was repeated using [RuCl₂(mesitylene)]₂ dimer instead of [RuCl₂(benzene)]₂ dimer or tri-aquo [(Ru)(mt)-(OH₂)₃]²⁺ instead of tri-aquo [(Ru)(bz)-(OH₂)₃]²⁺ to prepare [(mt)Rull(bpy)-OH₂]²⁺ (Cat 3H). In this synthesis a precursor composition according to [(mt)Ru^{II}(bpy)-Cl]⁺ was prepared as intermediate composition. The anion was chloro for the intermediate composition and nitrate in the final composition.

### EXAMPLE 12

Example 4 was repeated using [RuCl₂(mesitylene)]₂ dimer instead of [RuCl₂(benzene)]₂ dimer or tri-aquo [(Ru)(mt)-(OH₂)₃]²⁺ instead of tri-aquo [(Ru)(bz)-(OH₂)₃]²⁺ to prepare [(mt)Ru^{II}(H₂dcabpy)-OH₂]²⁺ (Cat 3-COOH). In this synthesis a precursor composition according to [(mt)Ru^{II}(H₂dcabpy)-Cl]⁺ was prepared as intermediate composition. The anion was chloro for the intermediate composition and nitrate in the final composition.

### EXAMPLE 13

Example 7 was repeated using [RuCl₂(mesitylene)]₂ dimer instead of [RuCl₂(benzene)]₂ dimer or tri-aquo [(Ru)(mt)-(OH₂)₃]²⁺ instead of tri-aquo [(Ru)(bz)-(OH₂)₃]²⁺ to prepare [(mt)Ru^{II}(H₄dphbpy)-OH₂]²⁺ (Cat 3-PO₃H₂).

In this synthesis a precursor composition according to [(mt)Ru^{II}(H₄dphbpy)-Cl]⁺ was prepared as intermediate composition. The anion was chloro for the intermediate composition and nitrate in the final composition.

### EXAMPLE 14

Example 1 was repeated using [RuCl₂(hexamethylbenzene)]₂ dimer instead of [RuCl₂(benzene)]₂ dimer or tri-aquo [(Ru)(hmbz)-(OH₂)₃]²⁺ instead of tri-aquo [(Ru)(bz)-(OH₂)₃]²⁺ to prepare the hexamethylbenzene (hmbz) ruthenium bipyridine composition according to [(hmbz)Ru^{II}(bpy)-OH₂]²⁺ (Cat 4H). In this synthesis a precursor composition according to [(hmbz)Ru^{II}(bpy)-Cl]⁺ was prepared as intermediate composition. The anion was chloro for the intermediate composition and nitrate in the final composition.

### EXAMPLE 15

Example 4 was repeated using [RuCl₂(hexamethylbenzene)]₂ dimer instead of [RuCl₂(benzene)]₂ dimer or tri-aquo [(Ru)(hmbz)-(OH₂)₃]²⁺ instead of tri-aquo [(Ru)(bz)-(OH₂)₃]²⁺ to prepare [(hmbz)Ru^{II}(H₂dcabpy)-OH₂]²⁺ (Cat 4-COOH). In this synthesis a precursor composition according to [(hmbz)Ru^{II}(H₂dcabpy)-Cl]⁺ was prepared as intermediate composition. The anion was chloro for the intermediate composition and nitrate in the final composition.

### EXAMPLE 16

Example 7 was repeated using [RuCl₂(hexamethylbenzene)]₂ dimer instead of [RuCl₂(benzene)]₂ dimer or tri-aquo [(Ru)(hmbz)-(OH₂)₃]²⁺ instead of tri-aquo [(Ru)(bz)-(OH₂)₃]²⁺ to prepare [(hmbz)Ru^{II}(H₄dphbpy)-0H₂]²⁺ (Cat 4-PO₃H₂). In this synthesis a precursor composition according to [(hmbz)Ru^{II}(H₄dphbpy)-Cl]⁺ was prepared as intermediate composition. The anion was chloro for the intermediate composition and nitrate in the final composition.

### EXAMPLE 17

Example 1 was repeated using [RuCl(pentamethylcyclopentadiene)]₄ tetramer instead of [RuCl₂(benzene)]₂ dimer in dichloromethane (DCM) or pentane to prepare a pentamethylcyclopentadiene (Cp*) ruthenium bipyridine composition according to [(Cp*)Ru^{II}(bpy)-OH₂]²⁺ (Cat 5-H). Instead of a [RuCl₂(benzene)]₂ dimer a [RuCl₂(Cp*)]ₙ polymer can also be used in the presence of 1-2 mmol of cobaltocene or zinc. In this synthesis a precursor composition according to [(Cp*)Ru^{II}(bpy)-Cl]⁺ was prepared as intermediate composition. The anion was chloro for the intermediate composition and nitrate in the final composition.

### EXAMPLE 18

Example 4 was repeated using [RuCl(pentamethylcyclopentadiene)]₄ tetramer instead of [RuCl₂(benzene)]₂ dimer in dichloromethane (DCM) or pentane to prepare [(Cp*)Ru^{II}(H₂dcabpy)-OH₂]²⁺ (Cat 5-COOH). Instead of a [RuCl₂(benzene)]₂ dimer a [RuCl₂(Cp*)]ₙ polymer can also be used in the presence of 1-2 mmol of cobaltocene or zinc. In this synthesis a precursor composition according to [(Cp*)Ru^{II}(H₂dcabpy)-Cl]⁺ was prepared as intermediate composition. The anion was chloro for the intermediate composition and nitrate in the final composition.

### EXAMPLE 19

Example 7 was repeated using [RuCl(pentamethylcyclopentadiene)]₄ tetramer instead of [RuCl₂(benzene)]₂ dimer in dichloromethane (DCM) or pentane to prepare [(Cp*)Ru^{II}(H₄dphbpy)-OH₂]²⁺ (Cat 5-PO₃H₂). Instead of a [RuCl₂(benzene)]₂ dimer a [RuCl₂(Cp*)]ₙ polymer can also be used in the presence of 1-2 mmol of cobaltocene or zinc. In this synthesis a precursor composition according to [(Cp*)Ru^{II}(H₄dphbpy)-Cl]⁺ was prepared as intermediate composition. The anion was chloro for the intermediate composition and nitrate in the final composition.

### EXAMPLE 20

Example 1 was repeated using [IrCl₂(pentamethylcyclopentadiene)]₂ dimer instead of [RuCl₂(benzene)]₂ dimer to prepare a 6-pentamethylcyclopentadiene (Cp*) iridium bipyridine composition according to formula [(Cp*)Ir^{III}(bpy)-OH₂]²⁺ (Cat 6H). In this synthesis a precursor composition according to [(Cp*)Ir^{III}(bpy)-Cl]⁺ was prepared as intermediate composition. The anion was chloro for the intermediate composition and nitrate in the final composition.

### EXAMPLE 21

Example 4 was repeated using [IrCl₂(pentamethylcyclopentadiene)]₂ dimer instead of [RuCl₂(benzene)]₂ dimer to prepare [(Cp*)Ir^{III}(H₂dcabpy)-OH₂]²⁺ (Cat 6-COOH). In this synthesis a precursor composition according to [(Cp*)Ir^{III}(H₂dcabpy)-Cl]⁺ was prepared as intermediate composition. The anion was chloro for the intermediate composition and nitrate in the final composition.

### EXAMPLE 22

Example 7 was repeated using [IrCl₂(pentamethylcyclopentadiene)]₂ dimer instead of [RuCl₂(benzene)]₂ dimer to prepare [(Cp*)Ir^{III}(H₄dphbpy)-OH₂]²⁺ (Cat 6-PO₃H₂). In this synthesis a precursor composition according to [(Cp*)Ir^{III}(H₄dphbpy)-Cl]⁺ was prepared as intermediate composition. The anion was chloro for the intermediate composition and nitrate in the final composition.

### EXAMPLE 23

Immobilization of the Cat 1-COOH to Cat 6-COOH or Cat 1-PO₃H₂ to Cat 1-PO₃H₂ compositions as prepared in Examples 4,9,12,15,18,21 or 7,10,13,16,19,22, respectively on the electrode was performed by carefully dropping a 15-25 μL aliquot of 0.1 mM catalyst solution on the ITO electrode during spinning up to 500 rpm. By this method, a smooth spreading of known amount of the catalyst (˜1.5−2.5×10⁻⁹ M per cm²) on ITO slide was obtained. The ITO was dried after each surface modification and gently dipped in water for 5 seconds. No detachment of the catalyst molecules were observed in the dipping water after analyzing it by UV-visible or Mass spectrometry. In the end, the catalyst modified ITO slides were put inside a groove (1.1×5 mm) of stainless steel rod (18 cm length and 0.5 cm diameter) and fixed with Teflon tape or Para-film.

### EXAMPLE 24

The cyclic voltammogram (CV) of the ITO electrode modified with Cat 1-COOH as prepared in Example 23 was measured in a 0.1 M aqueous phosphate buffer having a pH of 7.1. The scan rate was 50 mV sec⁻¹, the ITO area was 1 cm² and the catalyst density on the ITO electrode was 1.55×10⁻⁹ mol/cm².

The cyclic voltammogram (CV) is shown in FIG. 3. In FIG. 3 (a) indicates the Cat 2-COOH modified ITO and (b) relates to the blank ITO electrode. FIG. 3 shows that the onset of oxygen generation is at ca.1.45 V (vs. NHE) as compared to a blank ITO electrode (in the absence of the catalyst).

### EXAMPLE 25

Example 24 was repeated in a 0.1 M H₂SO₄ or HNO₃ aqueous solution. The scan rate was 50 mV sec⁻¹, the ITO area was 1 cm² and the catalyst density on the ITO electrode was 1.61×10⁻⁹ mol/cm².

The cyclic voltammograms (CV) of both experiments is shown in FIG. 4. FIG. 4 shows that the onset of oxygen generation is at about >1.85 V (vs. NHE) for both experiments.

### EXAMPLE 26

Steady state water electrolysis experiments were performed with the Cat 2-COOH modified ITO electrode of example 23, both in acidic and in neutral pH solutions. An electrolysis cell was used with separate anodic and cathodic compartments for oxygen generation and hydrogen evolution, connected by a channel of 4 cm length to avoid mixing of oxygen and hydrogen during catalytic water electrolysis. A platinum wire was used as secondary electrode for proton reduction.

FIG. 5 shows the current vs. time plot for the water electrolysis. In controlled-potential electrolysis of a neutral aqueous solution containing 0.1M phosphate buffer using the Cat 2-COOH modified ITO electrode (having a surface of 1 cm² and a catalyst density of 1.5×10⁻⁹ mol/cm²) at ca.1.45 V (vs NHE), the catalyst generates molecular oxygen with a turnover number of more than 3.1×10⁵ in 12 hours, at a turnover rate of 7.14 moles of oxygen per mole of catalyst per second (see insert in FIG. 5). Under steady state conditions, the average current density was more then 1.5 mA/cm².

The main graph of FIG. 5 shows the Steady state water electrolysis experiment using deoxygenated aqueous 0.1 M H₂50₄ at ˜1.87 V (vs. NHE) (having a surface of 1 cm² and a catalyst density of 1.5×10⁻⁹ mol/cm²).

### EXAMPLE 27

The oxygen generation rate (expressed in cumulative oxygen produced expressed in pmol) was measured under the conditions of Example 26 at ca. 1.87 V (vs. NHE (normal hydrogen electrode)). The ITO area was 1 cm² and the catalyst density on the electrode was 1.53×10⁻⁹ mol/cm².

The dotted line in FIG. 6 shows the oxygen generation versus time in hours for the deoxygenated aqueous 0.1 M HNO₃ or H₂SO₄ solutions. The solid line is the oxygen production under at these conditions, calculated from the turnover frequency.

The current density to attain a value is ca. 1.65 mA/cm². The catalyst turnovers were more than 3.1×10⁵ in 12 hours at a turnover rate of ˜7.14 moles of oxygen per mole of catalyst per second.

### EXAMPLE 28

In order to monitor the stability of the catalytic system for intermittent operation, successive electrolysis experiments were performed for consecutive time intervals with the Cat 2-COOH modified ITO electrode in a 0.1 M HNO₃ or 0.1 M H₂SO₄ aqueous solution at ca. 1.87 V (vs. NHE). The ITO surface area is 1 cm² and the catalyst density is 1.53×10⁻⁹ mol/cm².

FIG. 7 shows the activity of the catalyst for three electrolysis runs in a sequence, with a 2 hours break after 8 and 9 hours of operation. Down and up arrows in FIG. 7 indicate the on and off mode of the electrolysis. For every electrolysis run the rate of oxygen generation remains almost the same. This indicates an excellent stability of the Cat 2-COOH complex anchored on the ITO electrode in the acidic environment, also when the system is not being operated for a while, and the catalyst stays active and efficient when electrolysis is initiated again. This is especially advantageous for applications wherein the source of the power voltage is not constant like for example wind and solar power sources.

### EXAMPLE 29

Example 26 was repeated using Cat 2-COOH in aqueous acids (0.1 M HNO₃ or 0.1 M H₂SO₄). The measured oxygen generation turnover numbers (TON) were more than 6.7×10⁵ in 35 hours with turnover frequencies (TOF) of ˜5.33 moles of oxygen per mole of catalyst per second have been observed. One cm² of electrode covered with catalyst produced 800 μmol of oxygen in about 30 hours of water electrolysis at a current density of ˜1.65 mA/cm².

These numbers are well in excess of values reported for other known molecular catalysts for homogeneous and electro-catalytic oxygen evolution as illustrated in the below comparative experiments A and B.

Comparative Experiment A Experiment 26 was repeated using an ITO modified electrode linked with the below compound via a PO₃H₂ bridge. This catalyst is described in T. J. Meyer, Angew. Chem. Int. Ed., 48 (2009) 9473.

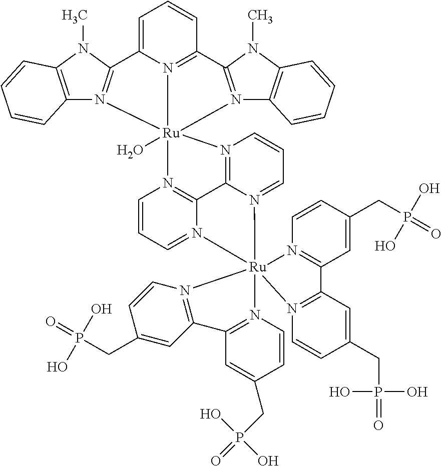

The experiment was performed in aqueous 1.0 M HClO₄ acids (pH ˜0). The oxygen generation turnover numbers (TON) were 2.8×10⁴ over a 13 hour period with turnover frequencies (TOF) of ˜0.6 moles of oxygen per mole of catalyst per second have been observed. The controlled potential water electrolysis was conducted at 1.8 V (vs. NHE) with no sign of reduction of the catalytic activity of the system.

Comparative Experiment B

Experiment 26 was repeated using a bis(ruthenium-hydroxo) complex on an ITO electrode. This catalyst system is described in K. Tanaka, Inorg. Chem. 40 (2001) 329.

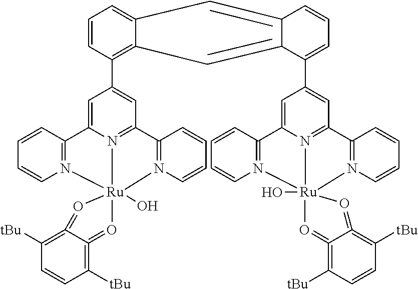

The experiment was performed in pH 4 (1.0 M H₃PO₄/KOH) aqueous solution. The oxygen generation turnover numbers (TON) were 3.35×10⁴ over 40 hour period with turnover frequencies (TOF) of ˜0.23 moles of oxygen per mole of catalyst per second have been observed. The complex was completely detached from the ITO surface in 40 hours time under controlled potential water electrolysis at 1.7 V (vs. Ag/AgCl).

### EXAMPLE 30

Experiment 26 was repeated using an ITO modified electrode linked with a [(Cp*)Ir^{III}(H₂dcabpy)-OH₂]²⁺ (Cat 6-COOH) of Example 21 in pH 5 (1.0 M H₃PO₄/KOH) aqueous solution. The anion was nitrate The measured oxygen generation turnover numbers (TON) were >2.5×10⁵ in about 12 hours with turnover frequencies (TOF) of ˜6.1 moles of oxygen per mole of catalyst per second have been observed. One cm² of electrode covered with catalyst produced ˜300 μmol of oxygen in about 10 hours of water electrolysis at a current density of ˜1.75 mA/cm².

### EXAMPLE 31

Experiment 26 was repeated with the compositions prepared in the above experiments as listed in the below Table 1. The measured TON and TOF are also listed in Table 1

TABLE 1

| | | | | Current |
|---|---|---|---|---|
| | | | Aqueous system | density |
| Catalyst | TON | TOF | (pH) | (mA/cm²) |
| Cat 2- | >3.1 × 10⁵ | 7.14 | KH₂PO₄/K₂HPO₄ | 1.55 |
| COOH | | | (7) | |
| Cat 2- | >2.3 × 10⁵ | 5.3 | H₂SO₄ (0-1) | 1.51 |
| PO₃H₂ | | | | |
| Cat 4- | >2.7 × 10⁵ | 5 | H₂SO₄ (0-1) | 1.53 |
| COOH | | | | |
| Cat 5- | >2.1 × 10⁵ | 6.5 | H₂SO₄ (0-1) | 1.63 |
| COOH | | | | |
| Cat 6- | >2.5 × 10⁵ | 6.1 | H₃PO₄/KOH (5) | 1.75 |
| COOH | | | | |

### EXAMPLE 32

The Pourbaix diagram was constructed for [Ru^{III}(OH)]²⁺/[Ru^{II}(OH₂)]²⁺, [Ru^{IV}(═O)]²⁺/[Ru^{III}(OH)]²⁺ and [Ru^{III}(OOH)]²⁺/[Ru^{IV}(═O)]²⁺ couples for Cat 2-COOH, generated at a glassy carbon disk (5 mm diameter) working electrode in 0.1 M aqueous solutions. FIG. 8 shows the potential versus pH plot for various ruthenium oxidations. In neutral solution, the water catalysis by [(cy)Ru^{II}(L₂-bpy)OH₂]²⁺ complex starts just above 1.41 V (vs. NHE) and the limiting step is the formation of [Ru^{III}(OOH)]²⁺ species with a standard free energy difference of 1.83 eV (pH=0) and at an overpotential ΔV=0.60 V for the full electrolysis reaction. Since this overpotential is quite close to the minimum overpotential of 0.4 V, there is near-optimal positioning of [Ru^{IV}(═O)]²⁺ intermediate with respect to the free energy levels of [Ru^{III}(OH)]²⁺ and [Ru^{III}(OOH)]²⁺ complexes.

From the Pourbaix diagram shown in FIG. 8, the electrochemical polarization for [Ru^{III}(OH)]²⁺/[Ru^{II}(OH₂)]²⁺, [Ru^{IV}(═O)]²⁺/[Ru^{III}(OH)]²⁺ and [Ru^{III}(OOH)]²⁺/[Ru^{IV}(═O)]²⁺ at pH=7 translates into the standard free energy differences of 0.67 eV, 1.27 eV and 1.83 eV respectively, at pH=0. Hence the difference in affinity between [Ru^{III}(OH)]²⁺ intermediate and [Ru^{III}(OOH)]²⁺ species for the complex [(cy)Ru^{II}(L₂-bpy)OH₂]²⁺ is 3.10 eV, which is well within the range of 3.2±0.2 eV calculated by Rosmeissl and Norskov in J. Phys. Chem. C, 111 (2007) 18821. As the standard free energy difference for the whole water splitting process is 4.92 eV, a non rate-limiting potential difference of 1.15 eV, for the last step towards oxygen evolution involving [Ru^{IV}(OO)]²⁺/[Ru^{III}(OOH)]²⁺ intermediate, needs to be overcome for this [(cy)Ru^{II}(L₂-bpy)OH₂]²⁺ catalyst.

The ecectrochemical redox behaviour of the complex [(cy)Ru^{II}(L₂-bpy)OH₂]²⁺ reveals a multiple pH dependent oxidations for [Ru^{III}—(OH)]²⁺/[Ru^{II}—(OH₂)]²⁺, [Ru^{IV}(═O)]²⁺/[Ru^{III}—(OH)]²+ and Ru^{III}—(OOH)]²⁺/[Ru^{IV}(═O)]²⁺ transitions as collected from the cyclic voltammetry (CV) in 0.1 M aqueous solutions. The Pourbaix diagram constructed for various ruthenium couples in the catalyst [(cy)Ru^{II}(L₂-bpy)OH₂]²⁺ is shown in FIG. 8. A ˜60 mV/pH shift of the equilibrium point for water oxidation is detected for positive potential scanning in aqueous solution over pH range from 2 to 12, which shows that the limiting step is a POET process for water oxidation. The pH-dependence of the transition from [Ru^{IV}(═O)]²⁺ to [Ru^{III}—OOH)]²⁺ intermediates reveals a POET mechanism and corresponding Nernst behavior of [Ru^{III}—OOH)]²⁺/[Ru^{IV}(═O)]²⁺ couple that determines the overpotential of the system.

This POET formation of [Ru^{III}—OOH)]²⁺ is not yet observed earlier for a molecular water oxidation catalyst. For instance, in recently reported mononuclear complexes by J. J. Concepcion et al., J. Am. Chem. Soc., 132 (2010) 1545, the rate-limiting step is independent of pH and involves the formation of a high energy [Ru^{V}(═O)]³⁺ intermediate via a non-POET step by one electron oxidation of [Ru^{IV}(═O)]²⁺ above 1.75 V (vs. NHE) before second OH₂ insertion. In this scheme, a subsequent OH₂ attack is rate limiting for O—O bond formation and is followed by release of a proton. Therefore, for catalyst Cat.2-COOH the oxygen generation occurs at less overpotential in neutral or higher pH aqueous solutions by following a 60 mV/pH slope due to POET formation of [Ru^{III}—OOH)]²⁺ intermediate.

In this example also the relative Gibbs free energies (AG) of reactive species and intermediates during catalytic water splitting and oxygen generation for [(cy)Ru^{II}(L₂-bpy)OH₂]²⁺ is compared with the free energy profiles for RuO₂, and the reaction coordinate for the optimal or ideal catalyst. For an optimal or ideal catalysts, the total free energy change for the water oxidation is ΔG=4.92 eV, which is distributed over the four steps between consecutive intermediates each having ΔG=1.23 eV. The results are shown in FIG. 9.

Since the complex [(cy)Ru^{II}(L₂-bpy)OH₂]²⁺ is the first molecular catalyst that exhibits a pH-dependent feature with the characteristic slope of ˜60 mV/pH and produces the catalytic intermediates independent of protons concentration, it was found that the chemical reference system can be changed to obtain a universal description of the cycle in terms of its free energy profile along a reaction coordinate that is delineated by the catalytic intermediates. The total free energy change for the water oxidation by [(cy)Ru^{II}(L₂-bpy)OH₂]²⁺ complex is ΔG=4.92 eV, which is distributed over the four steps between sequential intermediates: ΔG=0.67, 1.27, 1.83 and 1.15 eV. This free energy profile is compared with the standard free energies of the three intermediates in RuO₂ that were calculated with Density Functional Theory (DFT) calculations, and an optimal water oxidation catalyst with ΔG=1.23 eV for each of four steps. Catalytic water oxidation can proceed at the lowest potential when all steps are downhill. For RuO₂ this requires a minimum overpotential of ˜0.4 V, while the Cat 2-COON modified ITO operates at a moderate overpotential of just ˜0.6 V for thousands of cycles and thus represents a very good artificial system for water splitting.

In conclusion, we have discovered a new group of mononuclear water oxidation complexes and disclose a novel multi-electron catalytic system for water electrolysis based on a stable, easy accessible and highly efficient derived mono catalytic site water oxidation catalyst. The catalyst is electro-catalytically active and robust when anchored to the electrode surface by a linker group. It has been found possible to generate more than 400 μmol of oxygen in 11 hours in a controlled-potential water electrolysis setup at relatively low overpotential for the electrochemical cell with a stable current density >1.5 mA/cm² using Cat 2-COON modified ITO electrode according to the invention in a neutral solution.

1. A composition according to the following general formula:
[(BL)-(M)-(Ar)—(X)]n⁺ (A)ⁿ⁻
wherein M is a metal ion, BL is a bidentate ligand having two nitrogen atoms coordinating with a metal ion M, Ar is an, optionally substituted, conjugated cyclic hydrocarbon compound, X is H₂O and A is an anion and n in n+ and n− are individually chosen from 1,2,3,4 or 5.

2. The composition according to claim 1, wherein metal ion M is Ag, Au, Co, Fe, Ir, Mn, Mo, Ni, Os, Pd, Pt, Re, Rh and/or Ru.

3. The composition according to claims 2, wherein M is Ru, Ir, Mn, Co, Ni or Os.

4. The composition according to claims 2, wherein M is Ru or Ir.

5. The composition according to claim 1, wherein Ar is an optionally substituted conjugated cyclic hydrocarbon compound having 5, 6 or 8 carbons in the ring.

6. The composition according to claim 5, wherein Ar is cyclopentadiene, pentamethylcyclopentadiene, benzene, mesitylene, p-cymene, durene, hexamethyl benzene, cyclooctadiene and/or cyclooctatetradiene.

7. The composition according to claim 1, wherein anion A is Cl⁻, Br⁻, ClO₄⁻, CH₃COO⁻, NO₃⁻PF₆⁻, BF₄⁻, CO₃²⁻ and/or SO₄²⁻.

8. The composition according to claim 1, wherein the direct bridge connecting the two nitrogen atoms of the bidentate ligand BL contains two carbon atoms.

9. The composition according to claim 8, wherein BL is an optionally substituted 2,2′-bipyridine.

10. The composition according to claim 9, according to 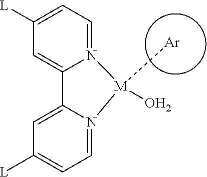
wherein M is Ir or Ru and L is —H, —PO₃H₂, —SH or —COOH.

11. The composition according to claim 10, wherein [(BL)-(M)-(Ar)—(X)]ⁿ⁺ is [(cy)Ru^{II}(H₂dcabpy)-OH₂]²⁺, wherein cy is p-cymene and H₂dcabpy is of 4,4′-dicarboxylic acid-2,2′-bipyridine.

12. -22. (canceled)

23. The composition according to claim 10, wherein Ar is cyclopentadiene, pentamethylcyclopentadiene, benzene, mesitylene, p-cymene, durene, hexamethyl benzene, cyclooctadiene and/or cyclooctatetradiene.

24. The composition according to claim 10, wherein anion A is Cl⁻, Br⁻, ClO₃⁻, ClO₄⁻, CH₃COO⁻, NO₃⁻, PF₆⁻, BF₄⁻, CO₃²⁻ and/or SO₄²⁻.

25. An electrode linked to a composition according to any one of claims 1-24.

26. The electrode according to claim 25, wherein the electrode is linked with a 2,2′-bipyridine ligand via a —SH, —COOH or —PO₃H₂ linker group, where linker groups are substituted at the 4,4′-positions of the 2,2′-bipyridine ligand.

27. The electrode according to claims 25, wherein the electrode is a triple-junction solar cell or a tandem cell.

28. A process for splitting water into oxygen and protons by means of electrolysis wherein a composition according to any one of claims 1-24 or an electrode according to any one of claims 25-27 is used.

29. The process according to claim 28, wherein the required overpotential of the electrolysis process is provided by a source of sustainable energy selected from wind, solar, wave or tidal power energy.

30. The process according to claim 28, wherein the protons as produced are used to prepare hydrogen, a chemical component or a carbon based fuel.

31. The process according to claim 30, wherein the carbon based fuel is methanol, ethanol or formic acid.
